(19) United States
(12) Patent Application Publication
(10) Pub. No.: US 2006/0294433 A1
(43) Pub. Date: Dec. 28, 2006

(54) Debugging using watchpoints

(76) Inventor: Greg William Thelen, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/169,236

(22) Filed: Jun. 28, 2005

(51) Int. Cl. G06F 11/00

(52) U.S. Cl. 714/38

(57) ABSTRACT

Techniques are disclosed for disabling watchpoint protection of a region of memory in a computer system, executing first program code that accesses a first memory location in the region of memory, and then enabling watchpoint protection of the region of memory.

### CROSS REFERENCE TO RELATED APPLICATIONS

This application is related to a commonly owned and concurrently filed U.S. patent application entitled “Debugging Using Virtual Watchpoints,” which is hereby incorporated by reference.

### BACKGROUND

Debugging computer programs can be tedious and time-consuming, in part because the program code responsible for a bug can be difficult to find. A serious software bug may be caused by a single instruction among millions of instructions in a computer program. Such an instruction may be difficult or prohibitively costly to find by manually inspecting every instruction in the program. As a result, software programs known as “debuggers” have long been used to facilitate the process of debugging.

One useful feature of conventional debuggers is the ability to execute a program until the program accesses a predetermined memory location. When the program accesses the predetermined memory location, the debugger halts execution of the program. This feature may be useful when it is suspected that the program is storing an incorrect value in the memory location or otherwise accessing the memory location in a way that is causing the program to malfunction. Halting execution of the program at this point enables the programmer to inspect the contents of the predetermined memory location in an attempt to identify the source of the bug being investigated.

Modern microprocessors typically include special “watchpoint registers” provided specially for use by debugger software in the circumstances described above. To execute a program until a predetermined range of memory locations is accessed, the debugger stores the range of addresses in a pair of watchpoint registers and then executes the program. The microprocessor then executes the program. When the program accesses a memory location in the predetermined range, a “watchpoint trap” is generated, which causes control to pass to the debugger. Providing this functionality directly in the hardware of the microprocessor enables programs being debugged to be executed much more rapidly than if such functionality were implemented in software.

It can still, however, be tedious and time-consuming to debug a program using the scheme described above. Assume, for example, that a program includes two instructions—A and B—both of which access the same predetermined memory region M. Assume that instruction A is the source of the bug under investigation, and that instruction B is not the source of any bug. In other words, instruction B accesses the predetermined memory region M in a valid way.

If the conventional scheme described above is applied in this situation, the range M will be stored in a pair of the microprocessor's watchpoint registers. The program will then be executed. The program will be halted every time instruction B accesses memory location in range M, even though instruction B is not the source of the bug under investigation. When the program is halted, the human operating the debugger software will need to inspect the program and determine whether instruction B is the source of a bug. This can be time-consuming. Furthermore, even if the human operator knows that instruction B is not the source of a bug, he must manually instruct the software debugger (such as by clicking on a “Continue” button) to resume execution of the program under test. This may need to be repeated a large number of times before instruction A, the true source of the bug under investigation, is executed. In short, the need for the human operator to manually acknowledge the execution of valid instructions may introduce significant inefficiency into the debugging process.

### SUMMARY

Techniques are disclosed for disabling watchpoint protection of a region of memory in a computer system, executing first program code that accesses a first memory location in the region of memory, and then enabling watchpoint protection of the region of memory.

Other features and advantages of various aspects and embodiments will become apparent from the following description and from the claims.

### BRIEF DESCRIPTION OF THE DRAWINGS

FIG. 1 is a diagram of a computer system according to one embodiment;

FIG. 2 is a flowchart of a method that is performed by the system of FIG. 1 to facilitate the process of debugging a computer program according to one embodiment;

FIG. 3. is a diagram of an example of pseudo-code representing instructions in the program under test in the system of FIG. 1 according to one embodiment; and

FIG. 4 is a table illustrating the effect of using the method of FIG. 2 to facilitate debugging according to one embodiment.

### DETAILED DESCRIPTION

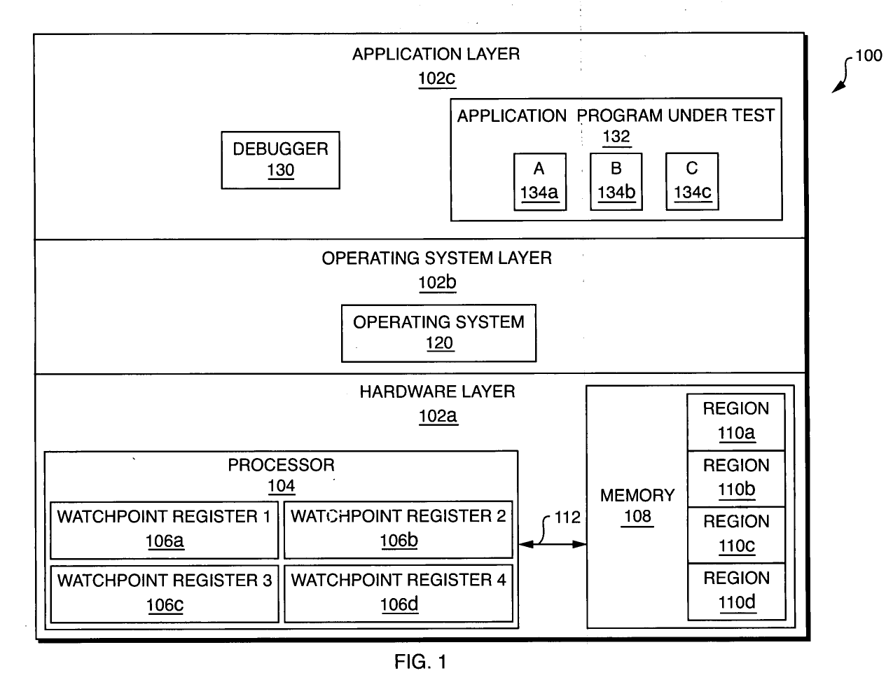

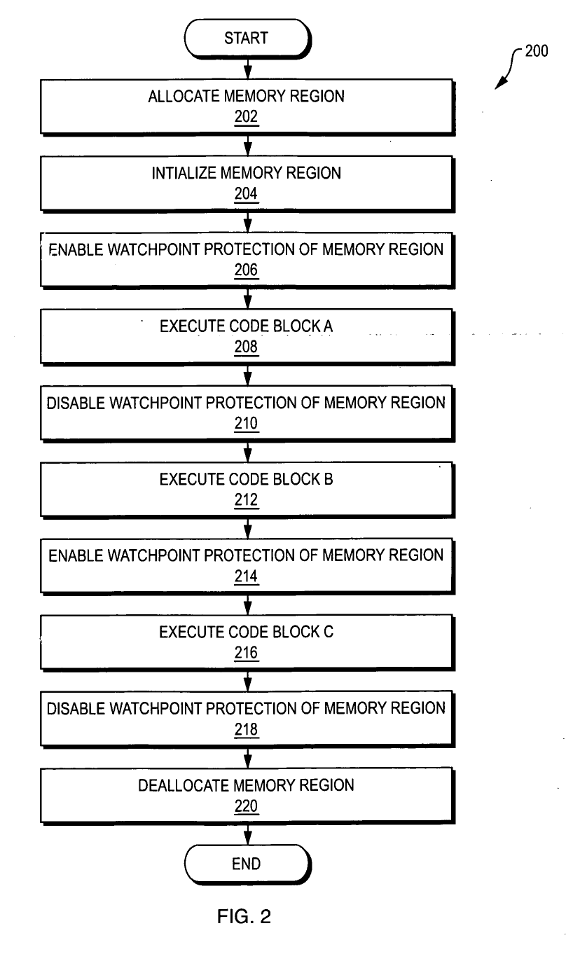

Referring to FIG. 1, a diagram is shown of a computer system 100 according to one embodiment. Referring to FIG. 2, a flowchart is shown of a method 200 that is performed by the system 100 of FIG. 1 to facilitate the process of debugging a computer program according to one embodiment.

The diagram in FIG. 1 illustrates the computer system 100 using three conceptual layers: a hardware layer 102a, an operating system (OS) layer 102b, and an application layer 102c. It is well-understood by those having ordinary skill in the art that the layers 102a-c in such a layered model do not necessarily represent distinct physical components in the computer system 100, but rather represent a combination of physical and functional models of the hardware and software in the computer system 100 in a manner that is useful for describing the operation of the system 100.

For example, the hardware layer 102a includes a processor 104 and a memory. The processor 104 need not be a single physical processor, but rather represents a processing subsystem that may include any number of processors and other components that interact to provide processing resources to the computer system 100. The processor 104 includes, among other things, a set of watchpoint registers 106a-d. Examples of processors that provide hardware watchpoints include the Intel x86 (a.k.a. IA32) line of processor and the Intel Itanium® line of processors. Although four watchpoint registers 106a-d are shown in FIG. 1, the processor 104 may include any number of watchpoint registers. Assume for purposes of example that a watchpoint for a first memory region may be enabled by storing the addresses of the lower and upper boundaries of the first memory region in the first and second watchpoint registers 106a and 106b, respectively. Similarly, assume for purposes of example that a watchpoint for a second memory region may be enabled by storing the addresses of the lower and upper boundaries of the second memory region in the third and fourth watchpoint registers 106c and 106d, respectively.

The hardware layer 102a also includes a memory 108. The memory 108 need not be a single physical memory, but rather represents a contiguous virtual memory space that may be implemented in one or more physical memories. For purposes of example, four memory regions 110a-d are demarcated in FIG. 1. The memory addresses stored in the watchpoint registers 106a-d of the processor 104 refer to memory locations in the memory 108.

The processor 104 and memory 108 communicate with each other over a bidirectional system bus 112. The processor 104 may read from and write to memory locations in the memory 108 over the system bus 112.

The computer system 100 also includes an operating system layer 102b. The operating system layer 102b is a software layer that includes an operating system 120. The operating system 120 may be any operating system, such as the Microsoft Windows Server 2003 operating system or any variant of the Linux operating system.

The computer system 100 also includes an application layer 102c that includes one or more application programs. In general, the operating system layer 102b acts as an intermediary between the application layer 102c and the hardware layer 102a. In the embodiment illustrated in FIG. 1, the application layer 102c includes two application programs: a debugger 130 and an application program under test 132. The application program 132 may be any application program that is being debugged by the debugger 130. The debugger 130 may be any debugger, such as the Microsoft WinDBG debugger or the GNU Project debugger (GDB).

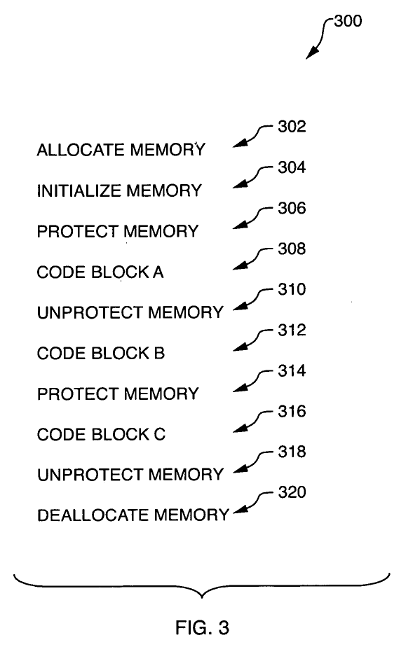

Referring to FIG. 3, a diagram is shown of an example of pseudo-code 300 representing instructions in the program under test 132. The pseudo-code may 300 may be implemented in any suitable programming language. Note that although individual elements in the pseudo-code 300 may be referred to herein as “instructions,” each such “instruction” may be implemented as one or more instructions in a particular programming language.

In the embodiment that will now be described, a human programmer or other operator of the computer system 100 has observed that the program under test 132 corrupts region 110a of the memory 108 when the program 132 is executed. The human operator does not, however, know which instruction or instructions in the program 132 are causing the memory corruption.

More specifically, assume for purposes of example that the program under test 132 includes, among other things, three blocks of code 134a-c, referred to herein as Code Block A 134a, Code Block B 134b, and Code Block C 134c. Assume that Code Block B 134b accesses memory region 110a and that the human operator believes or knows that Code Block B 134b is not the cause of the observed memory corruption. Assume further that the human operator does not know whether Code Block A 134a or Code Block C 134c is the cause of the observed memory corruption.

Because the human operator has observed that the program 132 corrupts memory region 110a, it may be desirable to execute the program 132 with a watchpoint enabled for region 110a. In other words, it may be desirable to execute the program 132 and for the program 132 to halt whenever a memory location in region 110a is accessed by the program 132. Because it is believed, however, that Code Block B 134b accesses region 110a without corrupting region 110a, it is further desirable that a watchpoint not be triggered when Code Block B 134b accesses region 110a.

As will be described in more detail below, the program under test 132 has been provided with instructions which enable a watchpoint to be triggered whenever code in Code Block A 134a or Code Block C 134c accesses memory region 110a, but not when code in Code Block B 134b accesses memory region 110a. As a result, the program under test 132 may be debugged more effectively because the human operator need not respond to accesses by Code Block B to memory region 110a.

The method 200 shown in FIG. 2 will now be described in more detail. The method 200 is performed by the computer system 100 when the program under test 132 is executed under observation of the debugger 130.

When the “Allocate Memory” instruction 302 (FIG. 3) in the program 132 is executed, the operating system 120 (FIG. 1) allocates a region of the memory 108 for use by the program 132 (FIG. 2, step 202). Assume for purposes of example that region 110a is the region that is allocated in step 202. Further assume that a human programmer or other operator of the computer system 100 has previously identified the memory region 110a as a region that is corrupted by the program 132 when the program 132 is executed.

When the “Initialize Memory” instruction 304 is executed, the operating system 120 initializes the allocated memory region 110a, such as by setting the values of all memory locations in the region 110a to zero (step 204). Conventional operating systems and programming languages provide mechanisms for performing steps 202 and 204. The instructions 302 and 304 may therefore be implemented using conventional program instructions carried out using well-known procedures.

When the “Protect Memory” instruction 306 is executed, the operating system 120 enables watchpoint protection of the memory region 110a (step 206). The phrase “watchpoint protection of a memory region” refers herein to associating a watchpoint with the memory region, so that accessing the memory region will trigger a fault or other mechanism whereby control is transferred to the debugger 130. Watchpoint protection may be enabled in step 206 using any mechanism. For example, the operating system 120 may enable watchpoint protection by storing the addresses of the lower and upper boundary of the memory region 110a in a pair of watchpoint registers (such as the watchpoint registers 106a-b) in the processor 104.

In one embodiment, the operating system 120 provides a function call that may be called by the program 132 to enable watchpoint protection of the memory region 110a. The “Protect Memory” instruction 306 may be implemented using such a function call. The “Protect Memory” function call may, for example, take three arguments: the lower and upper bounds of the memory region to be protected, and an identifier of the pair of watchpoint registers in which these bounds are to be stored. When the program 132 calls the “Protect Memory” function, the operating system 120 stores the specified lower and upper memory bounds in the specified pair of watchpoint registers.

Note that this is merely an example of how watchpoint protection may be enabled. Watchpoint protection may be enabled in other ways. For example, the debugger 130 rather than the operating system 120 may enable watchpoint protection on behalf of the program 132 by modifying the contents of the specified watchpoint registers.

The next portion 308 of the program 132 represents Code Block A 134a. Code Block A 134a may or may not access the region of memory 110a under suspicion, and the human operator may or may not know whether Code Block A 134a accesses memory region 110a. Code Block A 134a may, for example, be a portion of the program 132 which is suspected of containing a bug that causes the memory region 110a to become corrupted. The processor 104, under control of the operating system 120, executes the instructions in Code Block A 134a (step 208). Note that watchpoint protection of the memory region 110a is enabled while Code Block A 134a is executed because Code Block A 134a is under suspicion of containing a bug. If Code Block A 134a accesses any memory location in the protected memory region 110a, then the watchpoint will trigger and the operating system 120 will halt execution of the program 132 and transfer control to the debugger 130, which will indicate to the human operator that the watchpoint was triggered by Code Block A 134a. The human operator may then use the debugger 130 to attempt to determine whether Code Block A 134a is the source of a bug.

After Code Block A 134a has been executed, an “Unprotect Memory” instruction 310 in the program 132 is executed, thereby causing the operating system 120 to disable watchpoint protection of the memory region 110a (step 210). Such watchpoint protection may, for example, be disabled by clearing the contents of the watchpoint registers that were set in step 206.

The next portion 312 of the program 132 represents Code Block B 132b. As mentioned above, the human operator knows or believes that Code Block B 132b is not the source of the bug that corrupts memory region 110a. The human operator may, therefore, not want accesses by Code Block B 134b to memory region 110a to trigger a watchpoint and thereby cause execution of the program 132 to halt.

When Code Block B 134b is executed and accesses the memory region 110a (such as by reading from or writing to memory region 110a) (step 212), no watchpoint is triggered because watchpoint protection of the memory region 110a was disabled in step 210. Code Block B 134b may, therefore, access the memory region 110a an unlimited number of times without causing execution of the program 132 to halt and without requiring the human operator to inspect the program 132 or to manually acknowledge the memory access before execution of the program 132 can continue. Disabling watchpoint protection of the memory region 110a during execution of Code Block B 134b therefore saves time and effort on the part of the human operator.

When the “Protect Memory” instruction 314 is executed, the operating system 120 re-enables watchpoint protection of the memory region 110a (step 214). The next portion 316 of the program 132 represents Code Block C 134c. Code Block C 134c may or may not access the region of memory 110a under suspicion, and the human operator may or may not know whether Code Block C 134c accesses memory region 110a. Code Block C 134c may, for example, be a portion of the program 132 which is suspected of containing a bug that causes the memory region 110a to become corrupted. The processor 104, under control of the operating system 120, executes the instructions in Code Block C 134c (step 216). Note that watchpoint protection of the memory region 110a is enabled while Code Block C 134c is executed because Code Block C 134c is under suspicion of containing a bug. If Code Block C 134c accesses (reads or writes) any memory location in the protected memory region 110a, then the watchpoint will trigger and the operating system 120 will halt execution of the program 132 and transfer control to the debugger 130, which will indicate to the human operator that the watchpoint was triggered by Code Block C 134c. The human operator may then use the debugger 130 to determine whether Code Block C 134c is the source of a bug.

When the “Unprotect Memory” instruction 318 is executed, the operating system 120 disables watchpoint protection of the memory region 110a (step 218). When the “Deallocate Memory” instruction 320 of the program 132 is executed, the operating system 120 deallocates the memory region 110a (step 220).

Having described the execution of the code 300 shown in FIG. 3, it can be seen that disabling the watchpoint (instruction 310) before executing Code Block B 134b (instruction 312) allows Code Block B 134b to be executed without triggering the watchpoint. This can result in a considerable time savings to the human operator, particularly if Code Block B 134b accesses the memory region 110a a large number of times. Re-enabling the watchpoint (instruction 314) after executing Code Block B 134b allows the watchpoint to be triggered when other code blocks, such as Code Block C 134c, access the memory region 110a.

It should therefore be appreciated that the pseudo-code 300 shown in FIG. 3 may represent pre-existing code in which the human operator has inserted the “Protect Memory” instructions (306, 314) and the “Unprotect Memory” instructions (310, 318) at appropriate locations, such that the watchpoint for memory region 110a is enabled while Code Blocks A 134a and C 134c are executing, and disabled while Code Block B 134b is executing. The same strategy of inserting “Unprotect Memory” and “Protect Memory” instructions may be applied in any code to enable watchpoints while suspicious code blocks are executing, and to disable watchpoints while bug-free code blocks are executing.

Note that the same technique may be extended to apply to multiple memory regions. For example, although it might be known that Code Block B 134b does not corrupt memory range 110a, it might be suspected that Code Block B 134b corrupts memory region 110b. In such a case, the watchpoint on memory region 110a may be disabled when Code Block B 134b is executing, while the watchpoint on memory region 110b may be enabled when Code Block B 134b is executing.

Having described one embodiment in general, a particular example of an application of the method 200 of FIG. 2 will now be described. For purposes of this example, assume that Code Block A 134a does not access memory region 110a, that Code Block B 134b does access memory region 110a, and that Code Block C 134c also accesses memory region 110a.

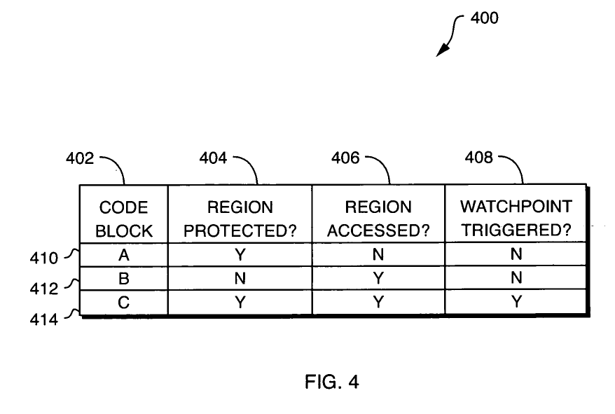

FIG. 4 shows a table 400 illustrating the effect of using the method 200 of FIG. 2 to facilitate debugging under these circumstances. The table 400 has three rows 410, 412, and 414, which indicate the outcome of executing Code Blocks A 134a, B 134b, and C 134c, respectively. The table 400 has the following columns: (1) “Code Block” 402, indicating the block of code being executed; (2) “Region Protected?” 404, indicating whether the memory region 110a is protected by a watchpoint while the corresponding block of code is being executed; (3) “Region Accessed?” 406, indicating whether the memory region 110a is accessed by the corresponding block of code; and (4) “Watchpoint Triggered?” 408, indicating whether the corresponding block of code triggers a watchpoint for memory region 110a.

Consider the first row 410, representing the outcome of executing Code Block A 134a. As indicated in column 404, the memory region 110a is protected by a watchpoint while Code Block A 134a is executed. This may be seen from the fact that the “Protect Memory” instruction 306 (FIG. 3) was executed before the execution of Code Block A 134a. In the present example, however, Code Block A 134a does not access memory region 110a, as indicated in column 406. Therefore, as indicated in column 408, the execution of Code Block A 134a does not trigger the watchpoint for memory region 110a in the present example.

Turning now to the second row 412, representing the outcome of executing Code Block B 134b, the memory region 110a is not protected by a watchpoint while Code Block B 134b is executed. This may be seen from the fact that the “Unprotect Memory” instruction 310 (FIG. 3) was executed before the execution of Code Block B 134b. In the present example, therefore, the watchpoint for memory region 110a is not triggered (column 408) even though Code Block B 134b accesses memory region 110a (column 406).

Finally, turning to the third row 414, representing the outcome of executing Code Block C 134c, the memory region 110a is protected by a watchpoint while Code Block C 134c is executed. This may be seen from the fact that the “Protect Memory” instruction 314 (FIG. 3) was executed before the execution of Code Block C 134c. In the present example, therefore, the watchpoint for memory region 110a is triggered (column 408) because Code Block C 134c accesses memory region 110a (column 406) while memory region 110a is protected by a watchpoint (column 404).

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Although the examples above use watchpoint registers 106a-d to enable and disable watchpoints, this is not a requirement of the present invention. Rather, mechanisms other than watchpoint registers may be used to implement watchpoints in conjunction with embodiments of the present invention. For example, watchpoints may be implemented in software by the operating system 120 and/or debugger 130.

The elements of the computer system 100 shown in FIG. 1 are provided merely for purposes of example and do not constitute a limitation of the present invention. Techniques disclosed herein may be used in conjunction with computer systems having elements other than those shown in FIG. 1.

Although certain functions are described in the examples above as being provided by the debugger 130, program 132, and operating system 120, such functions need not be provided by those particular elements. For example, the contents of the watchpoint registers may be modified by any one of the debugger 130, program 132, or operating-system 120.

Similarly, although the code of the program 132 is illustrated in FIG. 3 as including particular instructions for enabling and disabling watchpoints, this is merely an example and does not constitute a limitation of the present invention. For example, the user of the debugger 130 may inform the debugger 130 of those portions of the program 132 for which watchpoints are to be enabled. In response, the debugger 130 may enable and disable watchpoints while the program 132 is executing even if the program 132 does not include specific instructions for enabling and disabling watchpoints (e.g., instructions 306, 310, 314, and 318). Alternatively, the operating system 120 rather than the debugger 130 may perform such enabling/disabling of watchpoints.

Techniques disclosed herein may be used in conjunction with any kind of watchpoints. For example, processors typically allow the user to specify whether a particular watchpoint is to be triggered: (1) whenever a memory region is accessed; (2) only when the memory region is read; (3) only when the memory region is written; or (4) only when the memory region is executed. Techniques disclosed herein may be used in conjunction with watchpoints having these and other features.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method comprising:
(A) disabling watchpoint protection of a region of memory in a computer system;
(B) executing first program code that accesses a first memory location in the region of memory; and
(C) enabling watchpoint protection of the region of memory.

2. The method of claim 1, wherein the step (A) comprises:
(A)(1) identifying in the computer system at least one watchpoint register having contents that address the region of memory; and
(A)(2) modifying the contents of the at least one watchpoint register so that the contents do not address the region of memory.

3. The method of claim 1, wherein the step (B) comprises reading from the first memory location in the region of memory.

4. The method of claim 1, wherein the step (B) comprises writing to the first memory location in the region of memory.

5. The method of claim 1, wherein the step (B) comprises executing the first memory location in the region of memory.

6. The method of claim 1, further comprising:
(D) prior to (A), enabling watchpoint protection of the region of memory; and
(E) prior to (A), executing second program code that differs from the first program code.

7. The method of claim 6, wherein (E) comprises executing second program code that accesses a second memory location in the region of memory.

8. The method of claim 1, further comprising:
(D) after (C), executing second program code that differs from the first program code.

9. The method of claim 8, wherein (D) comprises executing second program code that accesses a second memory location in the region of memory.

10. The method of claim 9, wherein (D) comprises triggering a watchpoint trap.

11. An apparatus for use in a computer system, the computer system including a region of memory, the apparatus comprising:
first disabling means for disabling watchpoint protection of the region of memory in the computer system;
first executing means for executing first program code that accesses a first memory location in the region of memory; and
first enabling means for enabling watchpoint protection of the region of memory.

12. The apparatus of claim 11, wherein the first disabling means comprises:
means for identifying in the computer system at least one watchpoint register having contents that address the region of memory; and
means for modifying the contents of the at least one watchpoint register so that the contents do not address the region of memory.

13. The apparatus of claim 11, wherein the first executing means comprises means for reading from the first memory location in the region of memory.

14. The apparatus of claim 11, wherein the first executing means comprises means for writing to the first memory location in the region of memory.

15. The apparatus of claim 11, wherein the first executing means comprises means for executing the first memory location in the region of memory.

16. The apparatus of claim 11, further comprising:
second enabling means for enabling watchpoint protection of the region of memory prior to operation of the first disabling means; and
second executing means for executing second program code that differs from the first program code prior to operation of the first disabling means.

17. The apparatus of claim 11, further comprising:
second executing means for executing, after operation of the means for modifying, second program code that differs from the first program code.

18. A computer-readable medium comprising tangibly-embodied computer program instructions, the computer program instructions comprising:
first instructions for disabling watchpoint protection of a region of memory in a computer system;
first instructions for executing first program code that accesses a first memory location in the region of memory; and
first instructions for enabling watchpoint protection of the region of memory.

19. The computer-readable medium of claim 18, wherein the first instructions for disabling comprise:
instructions for identifying in the computer system at least one watchpoint register having contents that address the region of memory; and
instructions for modifying the contents of the at least one watchpoint register so that the contents do not address the region of memory.

20. The computer-readable medium of claim 18, wherein the first instructions for executing comprise instructions for reading from the first memory location in the region of memory.

21. The computer-readable medium of claim 18, wherein the first instructions for executing comprise instructions for writing to the first memory location in the region of memory.

22. The computer-readable medium of claim 18, wherein the first instructions for executing comprise instructions for executing the first memory location in the region of memory.

23. The computer-readable medium of claim 18, wherein the computer program instructions further comprise:
second instructions for enabling watchpoint protection of the region of memory prior to execution of the first instructions for disabling; and
second instructions for executing second program code that differs from the first program code prior to execution of the first instructions for disabling.

24. The computer-readable medium of claim 18, wherein the computer program instructions further comprise:
second instructions for executing, after execution of the instructions for modifying, second program code that differs from the first program code.
